(19) United States
(12) Patent Application Publication
(10) Pub. No.: US 2026/0159001 A1
(43) Pub. Date: Jun. 11, 2026

(54) FLEXIBLE SLIDING COVER FOR VEHICLE STORAGE COMPARTMENT BENEATH A VEHICLE HOOD

(71) Applicant: FCA US LLC, Auburn Hills, MI (US)

(72) Inventors: Ian R. Williams, Auburn Hills, MI (US); Jacob A. Lewis, Auburn Hills, MI (US); Dan C. Scruggs, II, Auburn Hills, MI (US)

(21) Appl. No.: 18/976,917

(22) Filed: Dec. 11, 2024

(51) Int. Cl. B60R 5/02; B60R 11/00

(52) U.S. Cl. CPC B60R 5/02; B60R 2011/0038; B60R 2011/0075

(57) ABSTRACT

A vehicle includes a storage compartment, arranged in a front compartment that is enclosed by a hood, a cover and a track. The storage compartment has an open top defined by one or more peripheral sidewalls that extend to a bottom wall that is vertically spaced from the top. The cover is slidably movable relative to the storage compartment and has a first position in which the cover encloses the top of the storage compartment and a second position in which at least part of the top of the storage compartment is open. The track has two guides that are at least partially curved in a vertical direction. And the cover slides within the guides as the cover moves between the first position and the second position, and the cover is flexible so that the cover follows the curvature of the guides.

### FIELD

The present disclosure relates to a flexible, sliding cover for a vehicle storage compartment that is located beneath a hood of the vehicle.

### BACKGROUND

Vehicle hoods are pivoted to the vehicle and swing about pivots in a vertical direction to provide access to a front compartment of the vehicle. Upon closing the hood, if an object is sticking up in the front compartment, the hood will contact the object and may become damaged. Some front compartments include a storage area in which objects can be stored in the vehicle. Without a lid, the storage compartments can become fouled by contaminants, and with a lid that moves vertically, objects that stick up beyond a top of the storage compartment can interfere with closing the lid, and can interfere with closing the hood. Damage to one or both of the lid and the hood can occur during attempted closure of the hood.

### SUMMARY

In at least some implementations, a vehicle includes a vehicle body, a storage compartment, a cover and a track. The vehicle body includes a front compartment and a hood, the hood is movable from a first position enclosing an upper side of the front compartment and a second position in which the hood is spaced from the front compartment to permit access to the front compartment. The storage compartment is carried by the vehicle body and located within the front compartment, the storage compartment has an open top defined by one or more peripheral sidewalls that extend to a bottom wall, and the bottom wall is vertically downwardly spaced from the top. The cover is slidably carried by the vehicle body and movable relative to the storage compartment, the cover has a first position in which the cover encloses the top of the storage compartment and the cover has a second position in which at least part of the top of the storage compartment is open. And the track has two guides arranged on opposite sides of the storage compartment adjacent to the top. The two guides each have front end, a first portion that extends away from the front end and that overlaps the top, and a second portion that is spaced from the top and that extends away from the first portion, and the second portion is at least partially curved in a vertical direction. Part of the cover is received within the guides, the cover slides within the guides as the cover moves between the first position and the second position, and the cover is flexible so that the cover follows the curvature in the second portion of each of the guides.

In at least some implementations, the second portion is curved downward, away from the top of the storage compartment.

In at least some implementations, the cover extends longitudinally and laterally across the open top of the storage compartment, and the longitudinal and lateral directions are perpendicular to each other and to the vertical direction.

In at least some implementations, the cover slides in a first direction, the guides are spaced apart in a second direction and extend in the first direction between the first end and the second portion, and the cover includes spaces that are oriented in the second direction and parallel to each other to permit cover to bend in a third direction.

In at least some implementations, a panel is received between the hood and the cover, the panel defines at least part of an opening to an interior of the storage compartment, and a seal is provided between the hood and the panel when the hood is in the first position.

In at least some implementations, the cover includes a first body defining an outer surface of the cover, and the cover includes a second body that is coupled to the first body, the second body includes multiple cross-members with spaces provided between at least part of adjacent cross-member, and the spaces are oriented perpendicular to a direction of movement of the cover. In at least some implementations, the direction of travel is perpendicular to the vertical direction. In at least some implementations, the first body is formed of plastic and is without any perforations or openings.

In at least some implementations, the guides include slots and wherein multiple ones of the cross-members include a guide portion and the guide portions are received within the slots and slide within the slots as the cover is moved. In at least some implementations, the cross-members are separate from each other and are connected at a first end to the first body. In at least some implementations, each cross-member includes a second end opposite to the first end, and the spaces extend to the second ends of each cross-member. In at least some implementations, the first body is a polymeric sheet of material and the second body is formed from a polymer.

In at least some implementations, a vehicle includes a vehicle body, a storage compartment, a track and a cover. The vehicle body includes a front compartment and a hood, the hood is movable from a first position enclosing an upper side of the front compartment and a second position in which the hood is spaced from the front compartment to permit access to the front compartment. The storage compartment is carried by the vehicle body and located within the front compartment, the storage compartment having an open top defined by one or more peripheral sidewalls that extend to a bottom wall. The bottom wall is spaced from the top in a vertical direction, the sidewalls are laterally and longitudinally spaced apart to define an interior of the storage compartment, and the lateral and longitudinal directions are perpendicular to the vertical direction. The track has two guides arranged on opposite sides of the storage compartment adjacent to the top, the two guides each have front end, a first portion that extends away from the front end and that overlaps the top, and a second portion that is spaced from the top and that extends away from the first portion, the first portion extends in either the longitudinal direction or the lateral direction and the second portion is at least partially curved in the vertical direction. The cover has a portion arranged in each of the two guides so that the cover is slidably movable relative to the storage compartment and the guides. The cover is flexible so that the cover follows the curvature in the second portion of each of the guides, the cover has a first position in which the cover encloses the top of the storage compartment and the cover has a second position in which at least part of the top of the storage compartment is open.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle;

FIG. 2 is a partial perspective view of part of a front compartment of the vehicle, showing a storage compartment;

FIG. 3 is a perspective view of the storage compartment and a panel, showing a cover over the storage compartment in an intermediate position;

FIG. 4 is a view similar to FIG. 3 with the cover in an open position;

FIG. 5 is perspective sectional view showing the storage compartment, the cover and a track along which the cover slides;

FIG. 6 is a side sectional view of the storage compartment, cover and track; and

FIG. 7 is a sectional view showing part of the cover and track.

### DETAILED DESCRIPTION

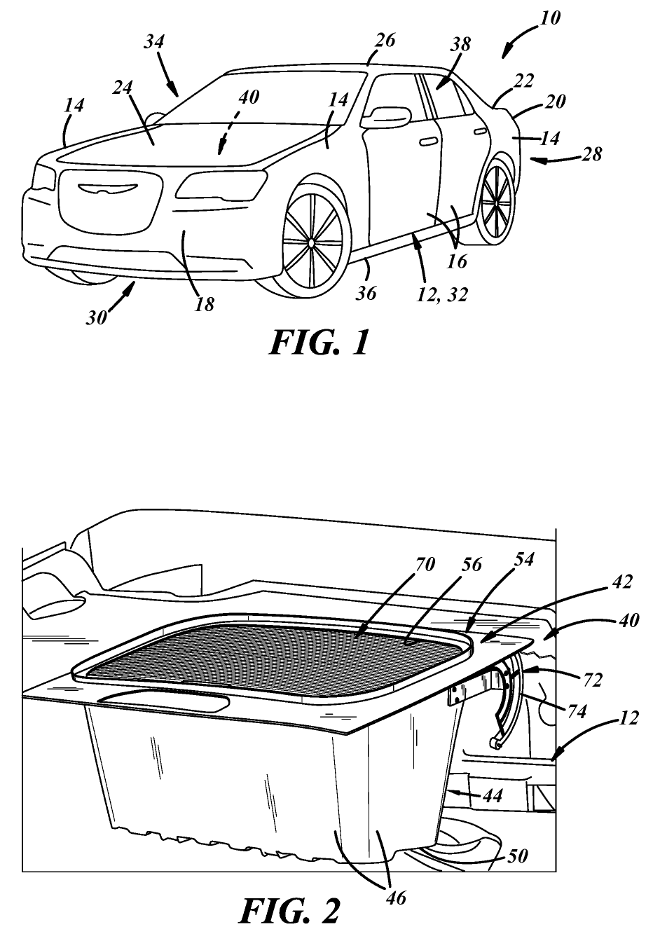

Referring in more detail to the drawings, FIG. 1 illustrates a vehicle 10 having a vehicle body 12 that is defined by structural elements enclosed in multiple body panels or exterior trim parts. The body panels and trim parts include, among others, side panels 14, doors 16, a front fascia 18 (sometimes called a front body module), rear fascia 20 (sometimes called a rear body module), rear trunk or deck lid 22, a front deck lid or hood 24 and a roof 26. The vehicle 10 includes a rear end 28 that is spaced from a front end 30 of the vehicle 10 in a first direction, which may be called a longitudinal direction, left and right sides 32, 34 are spaced apart in a second direction, which may be called a lateral direction, and a top (e.g. roof 26) and bottom 36 of the vehicle 10 are spaced apart in a third direction, which may be called a vertical direction.

In the example shown, the vehicle 10 includes a propulsion system having an engine, electric motor(s) or both, that are located in a compartment located adjacent to the rear end 28 of the vehicle 10, behind a passenger compartment 38 of the vehicle 10. In this arrangement, as shown in FIG. 2, a front compartment 40 of the vehicle 10, located between the passenger compartment 38 and the front end 30 of the vehicle 10 includes a storage compartment 42 in which cargo may be stored. The front compartment 40 is enclosed by the hood 24 which is pivoted to other parts of the vehicle body 12. The hood 24, sometimes called a hood, may be pivotably carried by structural components of the vehicle body 12 so that the hood 24 is movable to and between a first or closed position as shown in FIG. 1, and an open position in which an interior of the front compartment 40 may be accessed.

As shown in FIG. 2, with the propulsion components in or primarily in the rear of the vehicle 10, the storage compartment 42 can be provided in the front compartment 40, which is sometimes called a “frunk” which is short for a front trunk. The storage compartment 42 may be defined at least in part by a main body 44 that has one or more upstanding, vertically oriented sidewalls 46, that extend from an open top 48 to a bottom wall 50 that extends longitudinally and laterally from lower edges of the sidewall(s). An interior 52 of the storage compartment 42 in which things can be placed and retained is defined between the sidewalls 46 and the bottom wall 50. The main body 44 may be a molded polymeric body that is solid and continuous, without openings or perforations in the walls 46, 50, in at least some implementations. And the main body 44 may be mounted to one or more structural members of the vehicle body 12, such as by brackets or braces so that the storage compartment 42 is securely retained in the front compartment 40.

In at least some implementations, the storage compartment 42 may be connected to or aligned with a panel 54. The panel 54 may overlap part of the main body 44 and may have an opening 56 that is aligned with the open top 48 of the main body 44. The panel 54 may be flat or mostly flat, and have front and rear surfaces 58, 60 spaced apart on opposite ends of the opening 56 in the longitudinal direction, and left and right sides 62, 64 spaced apart on opposite sides of the opening 56 in the lateral direction. In at least some implementations, the panel 54 includes an upwardly, vertically oriented flange 66 that includes an upper end 68 that is vertically spaced from and above the top 48 of the storage compartment 42. A seal may be provided between the flange and the hood 24, when the hood 24 is closed. Among other things, the seal may inhibit water, dirt or other contaminants from entering the storage compartment 42 when the hood 24 is closed.

To permit the opening 56 and the top 48 of the storage compartment 42 to be selectively closed, a cover 70 is received beneath the panel 54 and overlying and/or surrounding the top 48 of the storage compartment 42. The cover 70 may be slidably partly received in and guided for movement in a track 72. The track 72 may include two guides 74 that are laterally spaced apart on opposite sides of the opening 56, are located beneath the panel 54 and extend longitudinally along the sides of the storage compartment 42, in at least some implementations. The guides 74 may be mirror images of each other and have slots 76 open inwardly, toward each other and in which peripheral side edges of the cover 70 are slidably received.

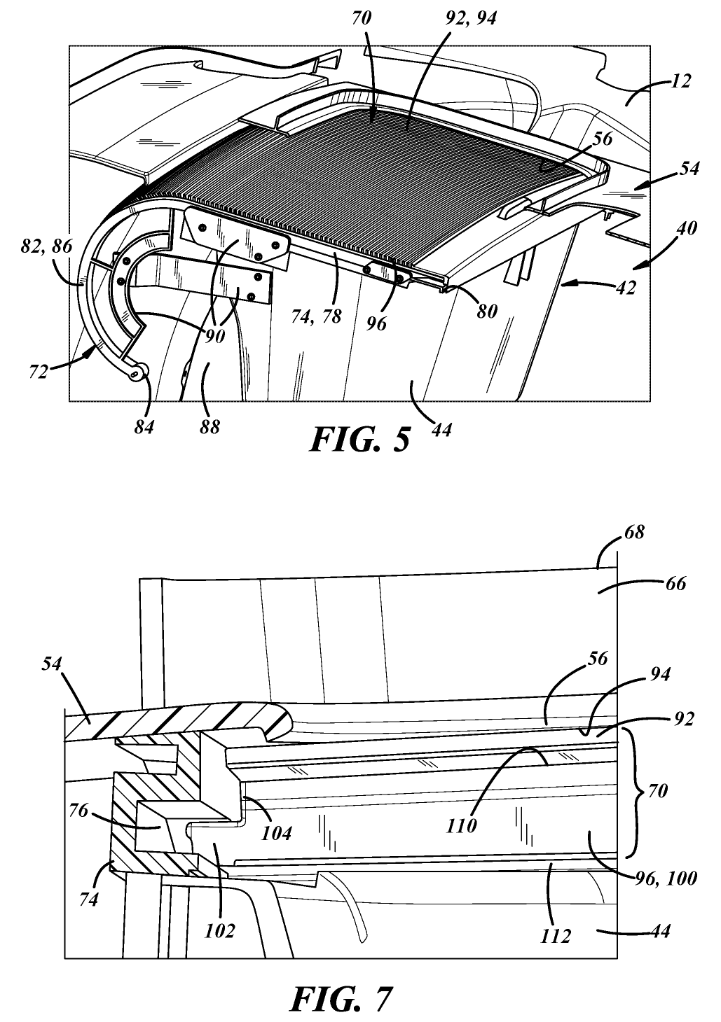

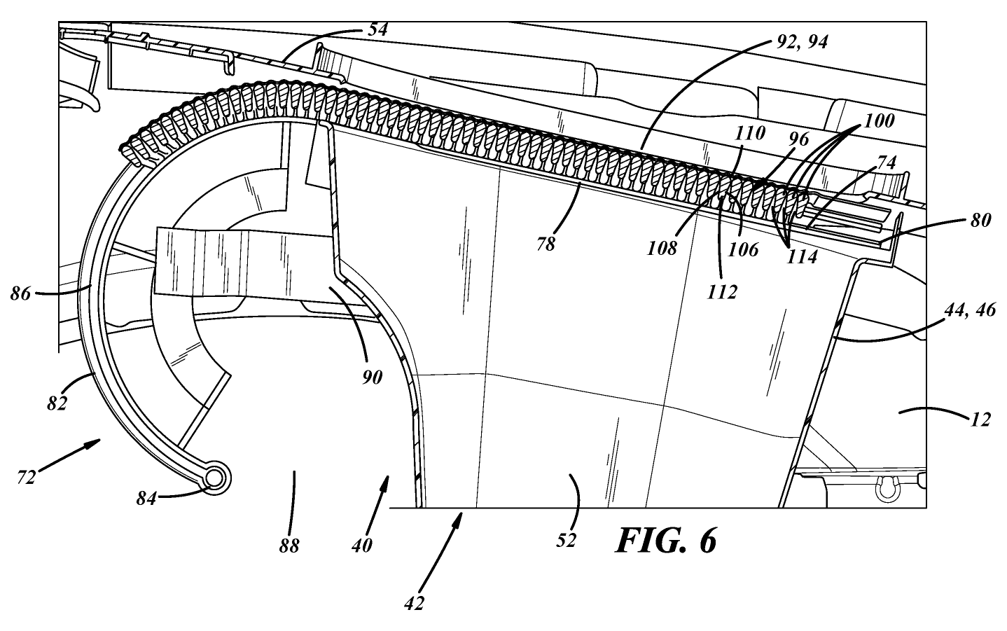

As shown in FIGS. 5 and 6, each guide 74 has a first portion 78 including or extending from a front end 80 that is located near a front of the storage compartment 42, and a second portion 82 that extends away from the first portion 78 to a second end 84. The first portion 78 may be linear and extend along the left and right sides of the storage compartment 42. The second portion 82 may be defined by or include a curved portion 86 that extends at least partly behind the storage compartment 42. This reduces the longitudinal extent that the guides 74 extend behind the storage compartment 42 and facilitate a more compact arrangement of the track 72 and cover 70. In the example shown in the drawings, there is an open space 88 in the front compartment 40 that is below the panel 54 and behind the main body 44, and the second portion 82 of the track 72 is received in that space 88. Rather than being curved downwardly, the second track 72 could curve upwardly if/when such space is open beneath the hood 24. The guides 74 may be connected, such as by brackets 90, to the panel 54, to the main body 44 or to other components in the front compartment 40, or any combination of these components, as desired.

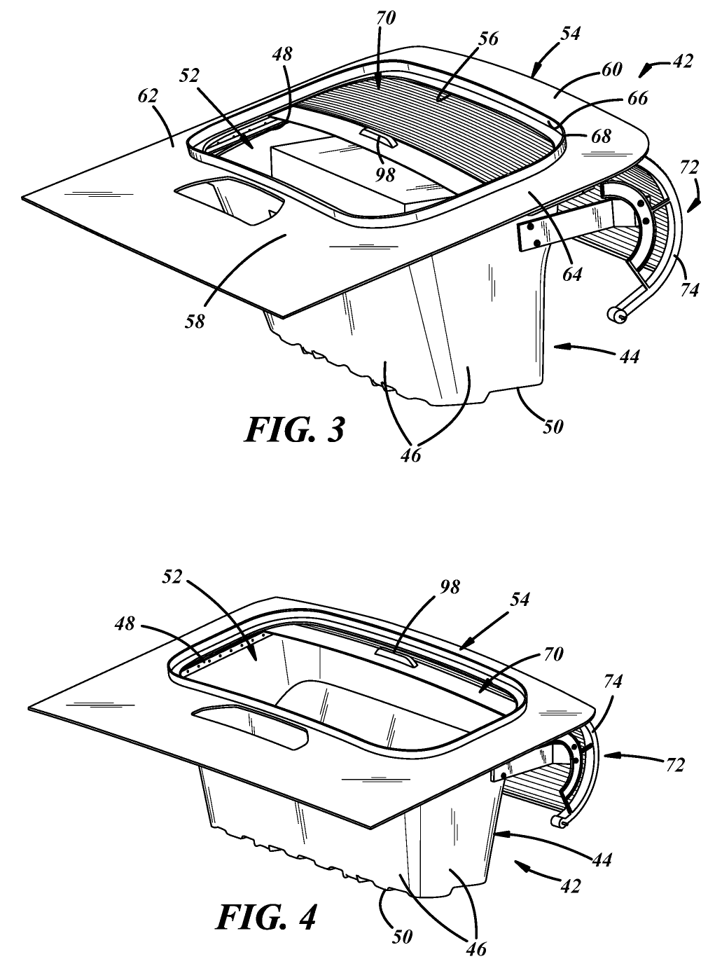

The cover 70 is arranged to be movable along and relative to the guides 74, and relative to the main body 44 of the storage compartment 42. The cover 70 has a first or closed position, shown in FIG. 2, in which the cover 70 completely overlaps the top 48 of the storage compartment 42, and a second position that is an at least partly open position (FIG. 3) in which the cover 70 does not completely overlap the storage compartment 42. In at least some implementations, the cover 70 may have a fully open position, as shown in FIG. 4) in which all or more than 80% of the surface area of the top 48 of the storage compartment 42 is exposed to permit items to be placed into or taken out of the interior 52 of the storage compartment 42.

As shown in FIGS. 5-7, the cover 70 may include a first body or outer sheet 92 that defines an upper/outer surface 94 of the cover 70 that is exposed within the opening 56, and provide a decorative or show surface of the cover 70. The outer sheet 92 may be a continuous sheet of a polymeric material, for example, without perforations or openings therethrough, in at least some implementations. The sheet has a length in the longitudinal direction, a width in the lateral direction and a thickness in the vertical direction, and the thickness is such that the sheet is flexible and bendable for bending movement as noted herein. To permit the cover 70 to flex and slide within the curved portion 86 of the guides 74, the outer sheet 92 is flexible, and the outer sheet 92 is bonded or otherwise connected to a flexible second or inner body 96. To facilitate moving the cover 70, a handle 98 (FIG. 3) may be provided in any desired manner and location.

So that the inner body 96 is flexible and can also travel about the curved, second portions 82 of the guides 74, the inner body 96 may be defined by a plurality of at least partly separate cross members 100 which may be formed from a polymeric material. The cross members 100 extend laterally the full lateral extent of the cover 70, and some and up to all of the cross members 100 include a guide portion 102, as shown in FIG. 7, at opposite ends that are received within the slots 76 of the guides 74. The cross members 100 provide structural integrity for the cover and prevent the cover from drooping into the interior 52 of the storage compartment 42. In this way, the cross members 100 are rigid, and individually do not flex significantly in the vertical direction.

The guide portions 102 may have a vertical height that is less than the vertical height of the slots 76, and a lateral length less than the lateral extent of the slots 76, so that there is some clearance between the guide portions 102 and the guides 74, to permit sliding movement of the guide portions 102 within the slots 76 of the guides 74. The guide portions 102 may have a vertical height less than the remainder of the cross members 100, providing a vertically oriented stop surface 104. The stop surface 104 limits lateral shifting or movement of the cover 70 relative to the guides 74, and prevents removal of the guide portions 102 from the slots 76, to retain the cover 70 between the guides 74.

The cross members 100 have a variable thickness in the longitudinal direction between front and rear surfaces 106, 108 (FIG. 6) of the cross members 100. At a first end 110, the cross members 100 are coupled to the outer sheet 92 and at a vertically opposite second end 112, the cross members 100 are separated from each other, and a slot or space 114 is provided between adjacent cross members 100, in at least some orientations of the cover 70 (e.g. portions of the cover 70 not within the curved portion 86 of the track 72). The cross members 100 may be separate from each other, that is, not directly connected together, along their vertical extents, or they may be interconnected/joined at a location spaced from the second ends 112. In the example shown in FIG. 6, the cross members 100 are wider at or near their first end 110 than at their second end 112, and may taper to the second end 112 to provide space 114 between the second ends 112 of adjacent cross members 100. The space 114 between adjacent cross members 100 accommodates relative movement of adjacent cross members 100 (e.g. they pivot about the first ends 110 that are attached to the outer sheet 92) to permit the cover 70 to flex and curve around the guides 74 as part of the cover 70 is moved in and out of the second portions 82 of the guides 74. The cross members 100 and the slots or spaces 114 between them are parallel to each other, and extend perpendicular to the direction of travel of the cover 70 and the direction in which the guides 74 are oriented. In the example shown, the cover 70 moves longitudinally and the cross members 100 and spaces 114 are oriented laterally.

So arranged, the cover 70 slides in a first direction (which is the longitudinal direction in the example shown) along the guides 74 as the cover 70 is moved to and between the closed and open positions. The portion of the cover 70 that is within the first portions 78 of the guides 74 moves along a horizontal plane (including the longitudinal and lateral directions or axes) with vertical movement in the first portion 78 of the guides 74 limited by engagement of the guide portions 102 with the guides 74 in the slots 76. The portion of the cover 70 that is within the second portion 82 of the guides 74 is curved about the guides 74, and the extent of the cover 70 that is within the second portion 82 of the guides 74 increases as the cover 70 is increasingly opened, and decreases as the cover 70 is moved toward the first/closed position.

In at least some implementations, at least some part of the cover 70 is received within the second portions 82 of the guides 74 when the cover 70 is in the first/closed position. By way of examples, one-third or more of the longitudinal length of the cover 70, or a length of the cover 70 sufficient to extend around at least one-third of the curved, second portion 82, may be within the second portions 82 of the guides 74 when the cover 70 is in the first position. Keeping some part of the cover 70 in the curved portions 86 of the guides 74 can help to keep the cover 70 oriented relative to the curved portion 86 of the guides 74. And this can reduce the force needed to move the cover 70 between its positions compared to implementations in which the cover 70 is removed from the second portions 82 in the closed position of the cover 70. In such implementations, a greater effort can be required to initially move part of the cover 70 in the curved, second portion 82, and this increased force may be undesirable to users, in at least some implementations. Of course, any arrangement may be used, as desired.

With the horizontally sliding cover 70, the cover 70 does not interfere with vertical movement/closing of the hood 24 over the front compartment 40. Further, items within the storage compartment 42 can be maintained out of the way of the hood 24 when the cover 70 is in the first, closed position. In this way, closing the cover 70 before closing the hood 24 is an easy way for users to ensure that no item within the storage compartment 42 will interfere with closing the hood 24. Such interference could lead to damage of the item, the hood 24, or both. The cover 70 can fully cover 70 the top 48 of the storage compartment 42, to limit vertical movement of items in the storage compartment 42 and inhibit contaminants from entering the interior 52 of the storage compartment 42 during use of the vehicle 10. While the cover 70 is shown and primarily described as moving in the longitudinal direction, the cover 70 could instead slide laterally. In such an implementation, the guides 74 could be arranged adjacent and parallel to the front and rear sides of the storage compartment 42, and the cross members 100 (and gaps therebetween) would be oriented in the longitudinal direction. Thus, the cover 70 slides in a first direction, the guides 74 are spaced apart in a second direction and extend in the first direction between the first end 110 and the second portion 82, and the cover 70 includes spaces 114 that are oriented in the second direction and parallel to each other to permit the cover to bend in a third direction.

The cover can be molded as an integral, one-piece component that can be assembled without requiring fasteners. The sliding cover can provide full access to the interior of the storage compartment, movement of the cover is not limited by the hood or other component, and the cover can be partially open/closed without interfering with closure of the hood, among other things. A lid that is pivoted for vertical movement relative to the storage compartment, on the other hand, requires a pivoted connection, such as a hinge and a latch to hold the lid closed, and fasteners. Such a vertically movable lid can interfere with loading items into the storage compartment (e.g. due to the hood limiting the extent to which the lid can be pivoted open), does not provide an easy height reference for objects in the storage compartment, and the lid can become misaligned, can interfere with closing the hood and can interfere with providing a seal with the hood.

What is claimed is:

1. A vehicle, comprising:
a vehicle body including a front compartment and a hood, the hood is movable from a first position enclosing an upper side of the front compartment and a second position in which the hood is spaced from the front compartment to permit access to the front compartment;
a storage compartment carried by the vehicle body and located within the front compartment, the storage compartment having an open top defined by one or more peripheral sidewalls that extend to a bottom wall, wherein the bottom wall is vertically downwardly spaced from the top;
a cover slidably carried by the vehicle body and movable relative to the storage compartment, the cover having a first position in which the cover encloses the top of the storage compartment and the cover has a second position in which at least part of the top of the storage compartment is open; and
a track having two guides arranged on opposite sides of the storage compartment adjacent to the top, the two guides each have front end, a first portion that extends away from the front end and that overlaps the top, and a second portion that is spaced from the top and that extends away from the first portion, the second portion is at least partially curved in a vertical direction wherein part of the cover is received within the guides, the cover slides within the guides as the cover moves between the first position and the second position, and wherein the cover is flexible so that the cover follows the curvature in the second portion of each of the guides.

2. The vehicle of claim 1 wherein the second portion is curved downward, away from the top of the storage compartment.

3. The vehicle of claim 1 wherein the cover extends longitudinally and laterally across the open top of the storage compartment, and the longitudinal and lateral directions are perpendicular to each other and to the vertical direction.

4. The vehicle of claim 1 wherein the cover slides in a first direction, the guides are spaced apart in a second direction and extend in the first direction between the first end and the second portion, and the cover includes spaces that are oriented in the second direction and parallel to each other to permit cover to bend in a third direction.

5. The vehicle of claim 1 which also includes a panel received between the hood and the cover, the panel defines at least part of an opening to an interior of the storage compartment, and a seal is provided between the hood and the panel when the hood is in the first position.

6. The vehicle of claim 1 wherein the cover includes a first body defining an outer surface of the cover, and the cover includes a second body that is coupled to the first body, the second body includes multiple cross-members with spaces provided between at least part of adjacent cross-member, and wherein the spaces are oriented perpendicular to a direction of movement of the cover.

7. The vehicle of claim 6 wherein the direction of travel is perpendicular to the vertical direction.

8. The vehicle of claim 6 wherein the first body is formed of plastic and is without any perforations or openings.

9. The vehicle of claim 6 wherein the guides include slots and wherein multiple ones of the cross-members include a guide portion and the guide portions are received within the slots and slide within the slots as the cover is moved.

10. The vehicle of claim 8 wherein the cross-members are separate from each other and are connected at a first end to the first body.

11. The vehicle of claim 10 wherein each cross-member includes a second end opposite to the first end, and the spaces extend to the second end of each cross-member.

12. The vehicle of claim 10 wherein the first body is a polymeric sheet of material and the second body is formed from a polymer.

13. A vehicle, comprising:
a vehicle body including a front compartment and a hood, the hood is movable from a first position enclosing an upper side of the front compartment and a second position in which the hood is spaced from the front compartment to permit access to the front compartment;
a storage compartment carried by the vehicle body and located within the front compartment, the storage compartment having an open top defined by one or more peripheral sidewalls that extend to a bottom wall, wherein the bottom wall is spaced from the top in a vertical direction, and the sidewalls are laterally and longitudinally spaced apart to define an interior of the storage compartment, where the lateral and longitudinal directions are perpendicular to the vertical direction;
a track having two guides arranged on opposite sides of the storage compartment adjacent to the top, the two guides each have front end, a first portion that extends away from the front end and that overlaps the top, and a second portion that is spaced from the top and that extends away from the first portion, the first portion extends in either the longitudinal direction or the lateral direction and the second portion is at least partially curved in the vertical direction; and
a cover having a portion arranged in each of the two guides so that the cover is slidably movable relative to the storage compartment and the guides, the cover is flexible so that the cover follows the curvature in the second portion of each of the guides, the cover has a first position in which the cover encloses the top of the storage compartment and the cover has a second position in which at least part of the top of the storage compartment is open.

14. The vehicle of claim 13 wherein the cover slides in a first direction, the guides are spaced apart in a second direction and extend in the first direction between the first end and the second portion, and the cover includes spaces that are oriented in the second direction and parallel to each other to permit cover to bend in a third direction.

15. The vehicle of claim 13 which also includes a panel received between the hood and the cover, the panel defines at least part of an opening to an interior of the storage compartment, and a seal is provided between the hood and the panel when the hood is in the first position.

16. The vehicle of claim 13 wherein the cover includes a first body defining an outer surface of the cover, and the cover includes a second body that is coupled to the first body, the second body includes multiple cross-members with spaces provided between at least part of adjacent cross-member, and wherein the spaces are oriented perpendicular to a direction of movement of the cover.

17. The vehicle of claim 16 wherein the guides include slots and wherein multiple ones of the cross-members include a guide portion and the guide portions are received within the slots and slide within the slots as the cover is moved.

18. The vehicle of claim 16 wherein the cross-members are separate from each other and are connected at a first end to the first body.

19. The vehicle of claim 18 wherein each cross-member includes a second end opposite to the first end, and the spaces extend to the second ends of each cross-member.

20. The vehicle of claim 18 wherein the first body is a polymeric sheet of material and the second body is formed from a polymer.
